(19) United States
(12) Patent Application Publication
(10) Pub. No.: US 2026/0154650 A1
(43) Pub. Date: Jun. 4, 2026

(54) COMPUTERIZED SYSTEMS AND METHODS FOR LOCATION MANAGEMENT

(71) Applicant: IRON HORSE AI PRIVATE LIMITED, Capitasky (SG)

(72) Inventors: Im Szu, Taipei (TW); Fan Szu, Taipei (TW); Michael Chu, Austin, TX (US)

(73) Assignee: IRON HORSE AI PRIVATE LIMITED, Capitasky (SG)

(21) Appl. No.: 19/132,587

(22) PCT Filed: Nov. 22, 2023
(86) PCT No.: PCT/IB2023/000706

§ 371 Date: May 23, 2025

Related U.S. Application Data
(60) Provisional application No. 63/428,000, filed on Nov. 25, 2022.

(51) Int. Cl. G06Q 10/0639; G05D 1/246; G05D 1/648; G05D 109/10; G05D 111/30; G06F 16/29; G06Q 10/0631; G06V 20/52; G06V 40/10; G06V 40/20; G08B 21/02; G08B 21/18

(52) U.S. Cl. CPC G06Q 10/06398; G05D 1/246; G05D 1/648; G06F 16/29; G06Q 10/063114; G06Q 10/06316; G06V 20/52; G06V 40/10; G06V 40/20; G08B 21/02; G08B 21/18; G05D 2109/10; G05D 2111/32

(57) ABSTRACT

Disclosed are systems and methods that provide a novel framework for centralized management of a location (e.g., jobsite, for example) and/or the users operating therein. The disclosed framework can operate so as to monitor the performance of tasks performed by users at a location, which can enable the determination of how effective, efficient, compliant and/or safe the user is being. Such information can be utilized to train machine learning and/or artificial intelligence (ML/AI) models that can be recursively applied to ensure performance levels and safety measures of each users'operation at the location. The framework can further be applied to compile learned activity behaviors into computer-executable instructions that can be used to automate certain tasks at the location via specifically configured real-world and/or digital assets (e.g., machinery or robotics at the jobsite, for example).

### CROSS REFERENCE TO RELATED APPLICATIONS

This application claims the benefit of priority from U.S. Provisional Application No. 63/428,000, filed Nov. 25, 2022, which is incorporated herein by reference in its entirety.

### FIELD OF THE DISCLOSURE

The present disclosure is generally related to a location monitoring and operations system, and more particularly, to a decision intelligence (DI)-based computerized framework for deterministically monitoring and tracking the activities of a user(s) at a location, and enabling management and performance of such activities based therefrom.

### BACKGROUND

Conventional mechanisms and protocols for managing a jobsite and the workers (or employees) operating therein are typically results-based. That is, the overall efficiency of the jobsite and the performance of its workers are traditionally based on which tasks are completed and which tasks remain outstanding.

### SUMMARY OF THE DISCLOSURE

Conventional worker and jobsite performance is typically determined by manager evaluation. That is, a manager, or other supervisory personnel, of a worker and/or a department at a jobsite can oversee how the workers are performing, and make determinations as to the performance and operational statuses of the workers and/or tasks based on perceived movements and completed tasks of each worker.

Most modern jobsites may be configured with cameras that capture or record user activities; however, these cameras positioned around the facility only capture the workers movements, and provide no insight to the levels and statuses of performance of each worker (e.g., whether the worker is fatigued, working more slowly than usual, displaying movements that correspond to an injury, stress or other forms of discomfort, and the like).

In some instances, jobsites may also have security and/or safety protocols implemented; however, not only are such protocols completely separate from performance monitoring, but they are also manually applied via managerial and/or security personnel. Indeed, conventional systems may utilize cameras and/or motion sensors, for example, to detect dangerous and/or risky behaviors; however, their implementation is entirely based on a user monitoring and/or providing input/feedback as to whether captured imagery of a worker corresponds to a situation of peril. For example, security personnel viewing closed-looped feeds of a jobsite to monitor activities of workers at the jobsite.

The disclosed systems and methods provide a novel computerized framework that addresses such shortcomings, among others, by automatically capturing and recording tracked movements of users respective to performed tasks at a location (e.g., a jobsite), and determining therefrom compliance and performance metrics, as well as safety measures for each worker. As discussed herein, the disclosed framework enables a collaboration between compliance, security and safety monitoring of a location and worker performance evaluation. The disclosed framework enables workers activities to be tracked, monitored and ensured according to compliance regulations and security/safety measures, which can be respective to the types of tasks they are performing and/or how (e.g., in what manner) they are performing such tasks. Accordingly, according to some embodiments, as discussed herein, the disclosed framework's operation can ensure that a worker(s) and/or the overall operation of a location (e.g., jobsite) are adhering to required, instituted and/or applied compliance regulations (e.g., either per jobsite and/or industry-wide, for example), performance metrics and/or safety/security measures/regulations, which can ensure a safe, secure, legal and efficient work environment, inter alia.

As evidenced from the disclosure herein, such performance and compliance monitoring, and safety measures can have benefits beyond simply determining whether tasks are being safely completed. According to some embodiments, as discussed in more detail below, the determined performance metrics can provide information related to, but not limited to, behaviors of the workers, patterns of each worker specific to a specific task, progress/performance of tasks, fatigue of the workers, efficiency of workers, security and/or safety risks associated with the workers'performance, whether the workers are complying with controlling legal laws and regulations, and the like, or some combination thereof.

In some embodiments, as discussed below, the performance metrics can be leveraged to generate and communicate real-time alerts, which can be sent to specific workers and/or administrators. For example, if a worker is detected as not performing a task at a level of efficiency and/or safety, a manager proximate to the worker's location can be alerted automatically.

In some embodiments, a worker's device can be caused to produce an output (e.g., an audio alert, haptic effect, and the like, for example), that can alert the user to a certain situation they are currently engaged in. For example, if a user is attempting to lift a box that is a certain size and weight, and the user's performance indicates they are currently operating at a level that indicates they are fatigued, then an alert may be triggered and sent to a device of the user (e.g., their smartphone and/or wearable sensor) that can alert the user to the dire situation they are about to embark on. In some embodiments, such alert can also be sent to a manager of the user, and/or another user determined to be proximately located to the user's current location (e.g., so as to encourage them to assist the user, for example).

In another example, if a user is operating machinery in a direction of a known/detected hazard (e.g., a spill of a liquid), then an alert can be automatically generated to notify the user of the hazard (and in some embodiments, as discussed below, re-route the user/machinery).

Moreover, according to some embodiments, the data collected and analyzed can be further compiled and utilized for real-world assets (e.g., computer operated machinery) to perform operational tasks at a location (e.g., jobsite). Thus, as discussed in more detail below, according to some embodiments, the disclosed framework can leverage tracked activities and behaviors of users to generate computer-executable instructions that a machine can operate, which can effectuate an automated operation of a task by the machine. Accordingly, in some embodiments, as discussed herein, the captured, learned, determined, detected or otherwise identified kinematics of workers can be compiled and transferred to robotic workers, thereby enabling their automatic operation based on the actions dictated/provided via the kinematics.

It should be understood that reference herein to “users” corresponds to people, workers, laborers or employees operating at a location. Moreover, a location can correspond to, but is not limited to, a jobsite, facility, building, factory, plant, home, and the like, and/or any other type of geographical area where user performance can be monitored.

Thus, as discussed herein, the disclosed systems and methods provide a centralized management of a location and/or users operating at such location based on detected, analyzed and monitored behaviors that can be leveraged to determine the performance and/or safety of such users, as well as automate certain activities for performance by computer-operated machinery.

According to some embodiments, a method is disclosed for a DI-based computerized framework for deterministically monitoring and tracking the activities of a user(s) at a location, and enabling management and performance of such activities based therefrom. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a DI-based computerized framework for deterministically monitoring and tracking the activities of a user(s) at a location, and enabling management and performance of such activities based therefrom.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3A and FIG. 3B illustrate exemplary data flows according to some embodiments of the present disclosure;

FIG. 4 illustrates an exemplary data flow according to some embodiments of the present disclosure;

FIG. 5 illustrates an exemplary data flow according to some embodiments of the present disclosure;

FIG. 6 depicts an exemplary implementation of an architecture according to some embodiments of the present disclosure;

FIG. 7 depicts an exemplary implementation of an architecture according to some embodiments of the present disclosure; and

FIG. 8 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, the disclosed framework provides novel capabilities for automatically capturing and recording tracked movements of users respective to performed tasks at a location (e.g., a jobsite), and determining therefrom performance metrics as well as safety measures for each worker. As discussed herein, the disclosed framework enables a collaboration between security and safety monitoring of a location and worker performance evaluation, whereby user safety can be tracked, monitored and ensured, which can be respective to the types of tasks they are performing and/or how (e.g., in what manner) they are performing such tasks.

Thus, as discussed herein, the disclosed systems and methods provide a centralized management of a location and/or users operating at such location based on detected, analyzed and monitored behaviors that can be leveraged to determine the performance and/or safety of such users, as well as automate certain activities for performance by computer-operated machinery.

By way of a non-limiting example, the disclosed framework can be utilized/implemented for, but not limited to, rank ordering of work, worker and/or jobsite performance, third party monitoring of workers (e.g., which can be performed via peer devices, monitoring devices and/or third party devices, for example) to ensure performance, compliance and/or safety, gathering of high-resolution evidence, determining if/when work, performance and/or other characteristics/features/attributes of a worker/jobsite are compliant with local/regional and/or universal guidelines, regulations and/or laws, scheduling or routing of workers (e.g., relocation or rebalancing of workforces across project zones and/or jobsites, for example), and the like, or some combination thereof.

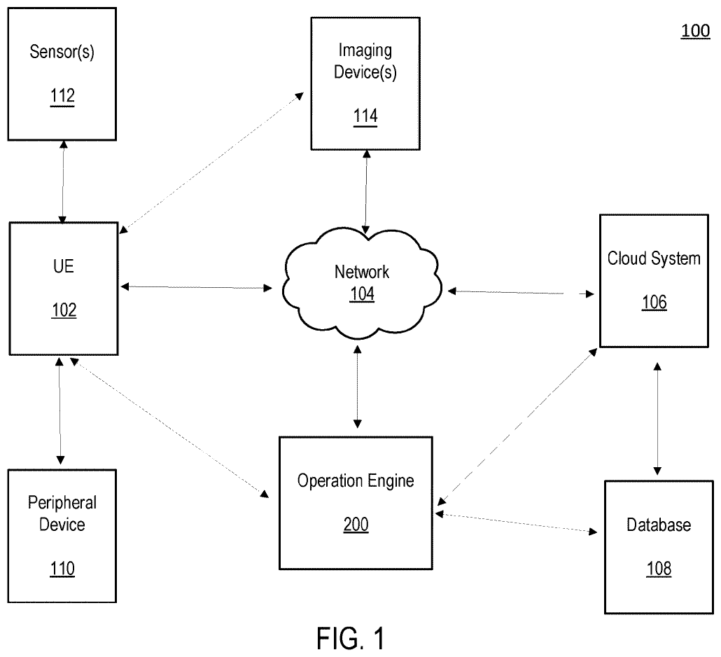

With reference to FIG. 1, system 100 is depicted, which can operate and/or be configured respective to a location. As discussed above, the location can correspond to, but is not limited to, a jobsite, facility, building, factory, plant, home, and the like, and/or any other type of geographical area where real-world and/or digital tasks can be performed/completed.

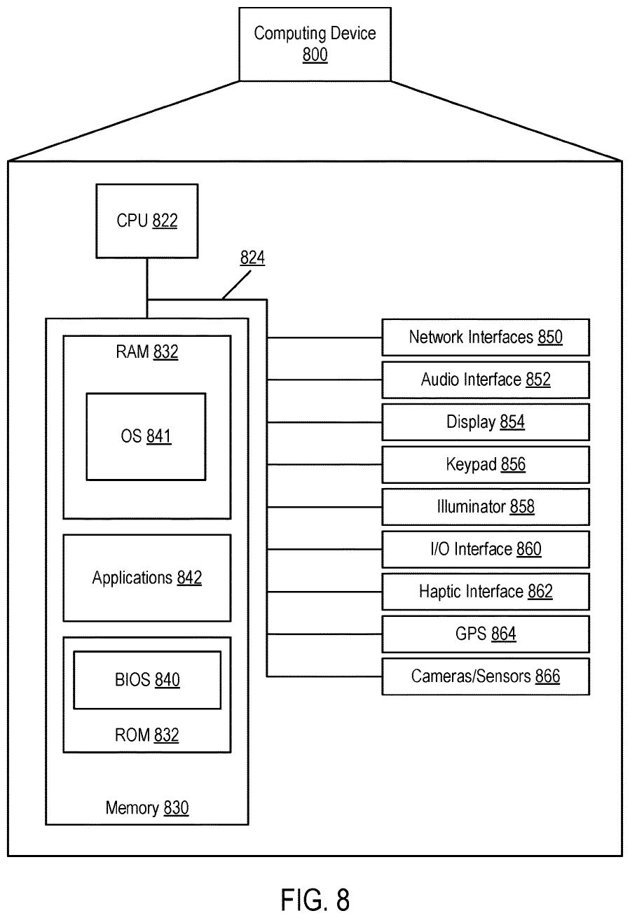

According to some embodiments, system 100 includes UE 102 (e.g., a client device, as mentioned above and discussed below in relation to FIG. 8), sensor(s) 112, peripheral device 110, network 104, cloud system 106, database 108, operation engine 200 and imaging device(s) 114. It should be understood that while system 100 is depicted as including such components, it should not be construed as limiting, as one of ordinary skill in the art would readily understand that varying numbers of UEs, peripheral devices, sensors, cloud systems, databases, networks and/or imaging devices can be utilized without departing from the scope of the instant disclosure; however, for purposes of explanation, system 100 is discussed in relation to the example depiction in FIG. 1.

According to some embodiments, UE 102 can be any type of device, such as, but not limited to, a mobile phone, tablet, laptop, sensor, wearable device, wearable camera, Internet of Things (IOT) device, autonomous machine, and any other type of modern device. In some embodiments, UE 102 can be a device associated with an individual (or set of individuals) for which security/safety services are being provided. In some embodiments, UE 102 may correspond to a device of a security entity (e.g., a security provider, whereby the device is a security panel and has corresponding sensors 112, as discussed herein).

In some embodiments, UE 102 may correspond to a reflective marker in which movement data may be tracked via an imaging device 114, as discussed infra.

In some embodiments, peripheral device 110 can be connected to UE 102, and can be any type of peripheral device, such as, but not limited to, a wearable device (e.g., smart watch), printer, speaker, sensor, and the like. In some embodiments, peripheral device 110 can be any type of device that is connectable to UE 102 via any type of known or to be known pairing mechanism, including, but not limited to, Bluetooth™, Bluetooth Low Energy (BLE), NFC, and the like.

According to some embodiments, a sensor 112 can correspond to sensors associated with a location of system 100. In some embodiments, UE 102 can have associated therewith a plurality of sensors 112 to collect data from a user. By way of a non-limiting example, the sensors 112 can include the sensors on UE 102 (e.g., smart phone) and/or peripheral device 110 (e.g., a paired smart watch). For example, sensors 112 may be, but are not limited to, an accelerometer or gyroscope that track a patient's movement. For example, an accelerometer may measure acceleration, which is the rate of change of the velocity of an object in meters per second squared (m/s²) or in G-forces (g). Thus, for example, the collected sensor data may indicate a patient's movements, breathing, restlessness, twitches, pauses or other detected movements and/or non-movements that may be common during a performance of a task. In some embodiments, sensors 112 also may track and/or collect x, y, z coordinates of the user and/or UE 102 in order to detect the movements of the user.

According to some embodiments, sensors 112 may be specifically configured for the positional placement respective to a user. For example, a sensor 112 may be situated on an extremity of a user (e.g., arm or leg) and/or may be configured on a user's chest (e.g., a body camera, such as, for example, a hand-word, foot-worn and/or head/helmet-worn camera). Such sensors 112 can be affixed to the user via the use of bands, adhesives, straps, and the like, or some combination thereof. For example, a sensor can be a fabric wristband (or other type of material/clothing) that has contrast points for detection by an imaging modality (e.g., imaging device 114, for example; and/or a camera associated with UE 102, for example).

According to some embodiments, one or more of the sensors 112 may include, but are not limited to, a temperature sensor, a thermal gradient sensor, a barometer, an altimeter, an accelerometer, a gyroscope, a humidity sensor, a magnetometer, an inclinometer, an oximeter, a colorimetric monitor, a sweat analyte sensor, a galvanic skin response sensor, an interfacial pressure sensor, a flow sensor, a stretch sensor, a microphone, and the like, and/or any combination thereof.

According to some embodiments, sensors 112 may be integrated into the operation of the UE 102 in order to monitor the status of a user. In some embodiments, the data acquired by the sensors 112 may be used to train a machine learning and/or artificial intelligence (ML/AI) algorithm used by the UE 102 and/or artificial intelligence to control the UE 102. According to some embodiments, such ML/AI can include, but are not limited to, computer vision, neural network analysis, and the like, as discussed below.

In some embodiments, the sensors 112 can be positioned at particular positions (or sub-locations) of the location. Such sensors can enable the tracking of positions, movements and/or non-activity of a user, as discussed herein. In some embodiments, such sensors can be associated with security sensors, such as, for example, cameras, motion detectors, door and window contacts, heat and smoke detectors, passive infrared (PIR) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof.

According to some embodiments, imaging device 114 refers to a device used to acquire, capture and/or record imagery (e.g., take pictures and/or record video, for example). For example, imaging device 114 can effectuate image capture by any type of known or to be known mechanisms. For example, imaging device 114 can be, but is not limited to, a camera, infrared camera, thermal camera, and the like (e.g., any type of known or to be known camera that is sensitive to visible and non-visible spectrums). Thus, imaging device 114 can include any device capable of mechanical, digital and/or electric device that can capture and/or record a visual image or set of visual images (e.g., an image burst or video frames, for example).

Accordingly, in some embodiments, imaging device 114 may receive or generate imaging data from a plurality of imaging devices 106. An imaging device(s) 106 may include, but are not limited to, for example, a camera worn by a user(s) (e.g., a body camera (e.g., a hand-word, foot-worn and/or head/helmet-worn camera, for example)), cameras mounted to the ceiling or other structure at, around, above or below a jobsite and/or machinery, cameras that may be mounted on a tripod or other independent mounting device, cameras that may be incorporated into a wearable device (e.g., UE 102), such as an augmented reality device like Google® Glass, Microsoft® HoloLens, and the like, cameras that may be integrated into machinery, or any camera or other imaging device 114 that may be present at a jobsite.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a security system provider, which has associated network resources hosted on the internet or private network (e.g., network 104), which enables (via engine 200) the worker safety management discussed herein.

In some embodiments, cloud system 106 may be a private cloud, where access is restricted by isolating the network such as preventing external access, or by using encryption to limit access to only authorized users. Alternatively, cloud system 106 may be a public cloud where access is widely available via the internet. A public cloud may not be secured or may be include limited security features.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102/device 110 and the UE 102/device 110, sensors 112, imaging device 114, and the services and applications provided by cloud system 106 and/or operation engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

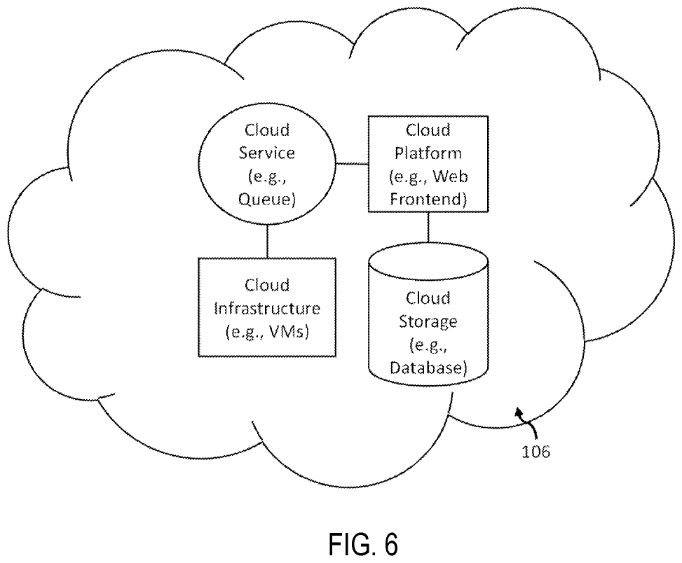

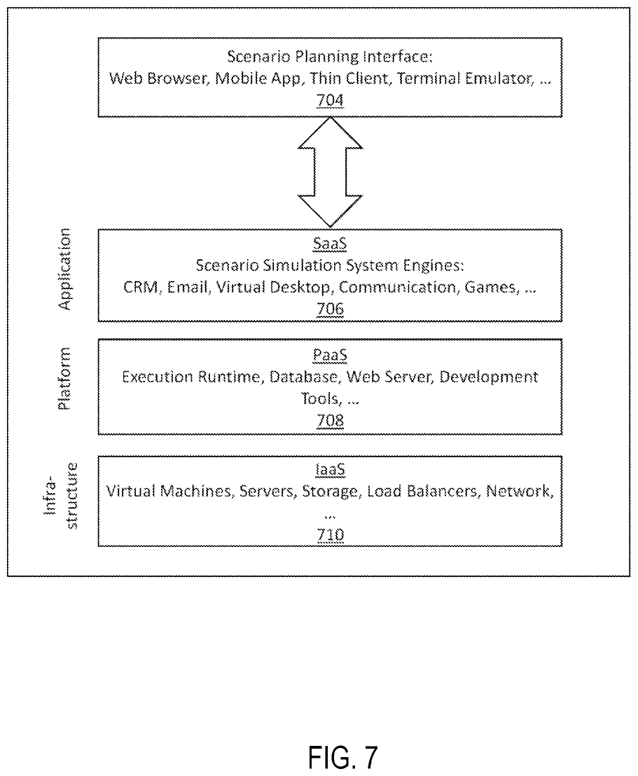

Turning to FIG. 6 and FIG. 7, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 710, platform as a service (PaaS) 708, and/or software as a service (SaaS) 706 using a web browser, mobile app, thin client, terminal emulator or other endpoint 704. FIG. 6 and FIG. 7 illustrate schematics of non-limiting implementations of the cloud computing/architecture(s) in which the exemplary computer-based systems for administrative customizations and control of network-hosted APIs of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL).

According to some embodiments, database 108 may correspond to a distributed ledger of a distributed network. In some embodiments, the distributed network may include a plurality of distributed network nodes, where each distributed network node includes and/or corresponds to a computing device associated with at least one entity (e.g., the entity associated with cloud system 106, for example, discussed supra). In some embodiments, each distributed network node may include at least one distributed network data store configured to store distributed network-based data objects for the at least one entity. For example, database 108 may correspond to a blockchain, where the distributed network-based data objects can include, but are not limited to, account information, medical information, entity identifying information, wallet information, device information, network information, credentials, security information, permissions, identifiers, smart contracts, transaction history, and the like, or any other type of known or to be known data/metadata related to an entity's and/or user's information, structure, business and/or legal demographics, inter alia.

In some embodiments, a blockchain may include one or more private and/or private-permissioned cryptographically-protected, distributed databased such as, without limitation, a blockchain (distributed ledger technology), Ethereum (Ethereum Foundation, Zug, Switzerland), and/or other similar distributed data management technologies. For example, as utilized herein, the distributed database(s), such as distributed ledgers ensure the integrity of data by generating a digital chain of data blocks linked together by cryptographic hashes of the data records in the data blocks. For example, a cryptographic hash of at least a portion of data records within a first block, and, in some cases, combined with a portion of data records in previous blocks is used to generate the block address for a new digital identity block succeeding the first block. As an update to the data records stored in the one or more data blocks, a new data block is generated containing respective updated data records and linked to a preceding block with an address based upon a cryptographic hash of at least a portion of the data records in the preceding block. In other words, the linked blocks form a blockchain that inherently includes a traceable sequence of addresses that may be used to track the updates to the data records contained therein. The linked blocks (or blockchain) may be distributed among multiple network nodes within a computer network such that each node may maintain a copy of the blockchain. Malicious network nodes attempting to compromise the integrity of the database must recreate and redistribute the blockchain faster than the honest network nodes, which, in most cases, is computationally infeasible. In other words, data integrity is guaranteed by the virtue of multiple network nodes in a network having a copy of the same blockchain. In some embodiments, as utilized herein, a central trust authority for sensor data management may not be needed to vouch for the integrity of the distributed database hosted by multiple nodes in the network.

In some embodiments, exemplary distributed blockchain-type ledger implementations of the present disclosure with associated devices may be configured to affect transactions involving Bitcoins and other cryptocurrencies into one another and also into (or between) so-called FIAT money or FIAT currency, and vice versa.

In some embodiments, the exemplary distributed blockchain-type ledger implementations of the present disclosure with associated devices are configured to utilize smart contracts that are computer processes that facilitate, verify and/or enforce negotiation and/or performance of one or more particular activities among users/parties. For example, an exemplary smart contract may be configured to be partially or fully self-executing and/or self-enforcing. In some embodiments, the exemplary inventive asset-tokenized distributed blockchain-type ledger implementations of the present disclosure may utilize smart contract architecture that may be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. For example, each node may also check the work of other nodes and in some cases, as noted above, function as miners or validators.

Operation engine 200, as discussed above and further below in more detail, can include components for the disclosed functionality. According to some embodiments, operation engine 200 may be a special purpose machine or processor, and can be hosted by a device on network 104, within cloud system 106 and/or on UE 102 (and/or peripheral device 110). In some embodiments, engine 200 may be hosted by a server and/or set of servers associated with cloud system 106.

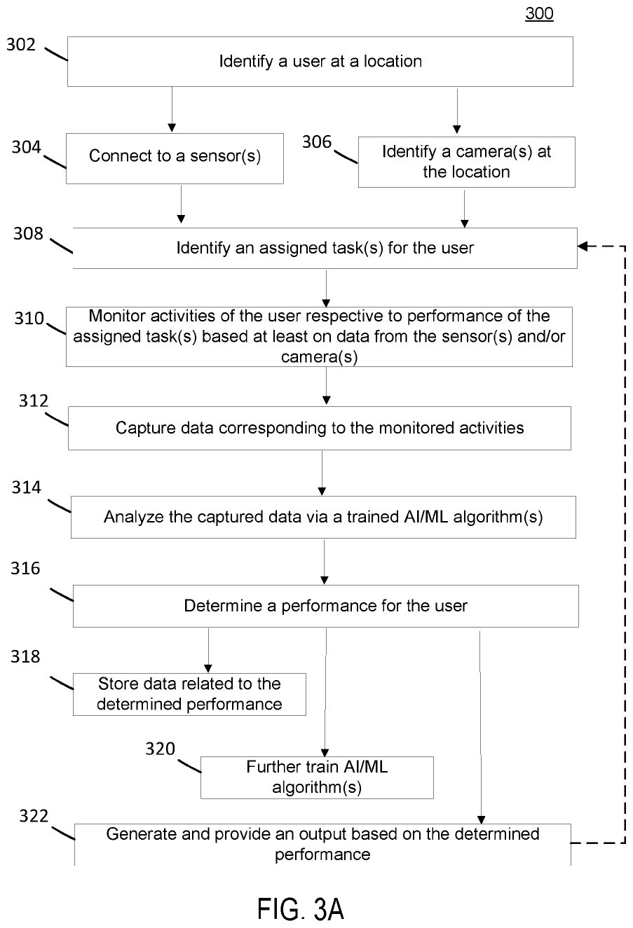

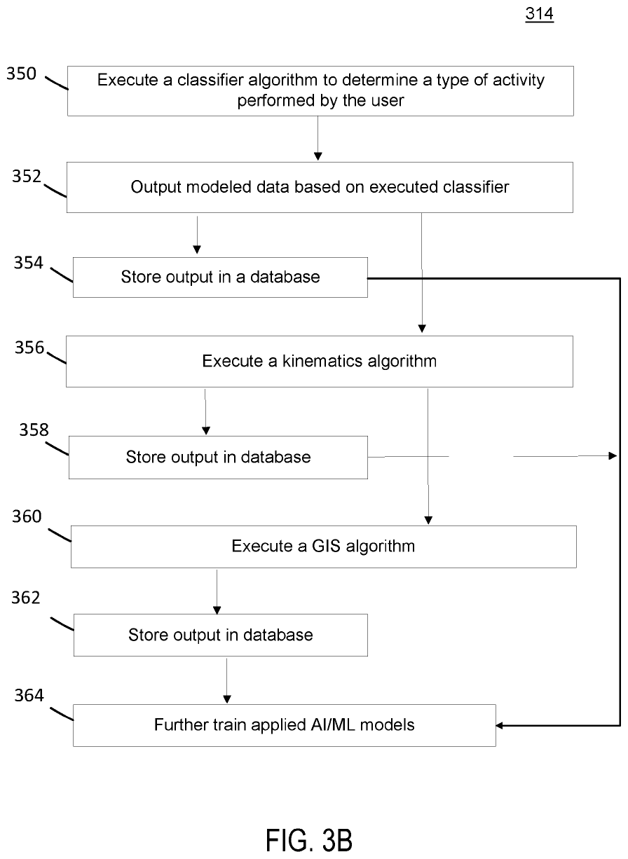

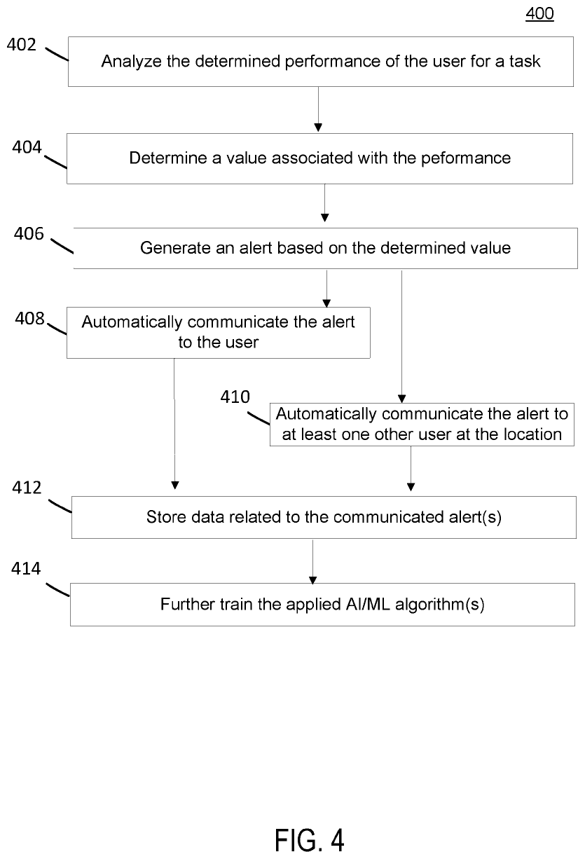

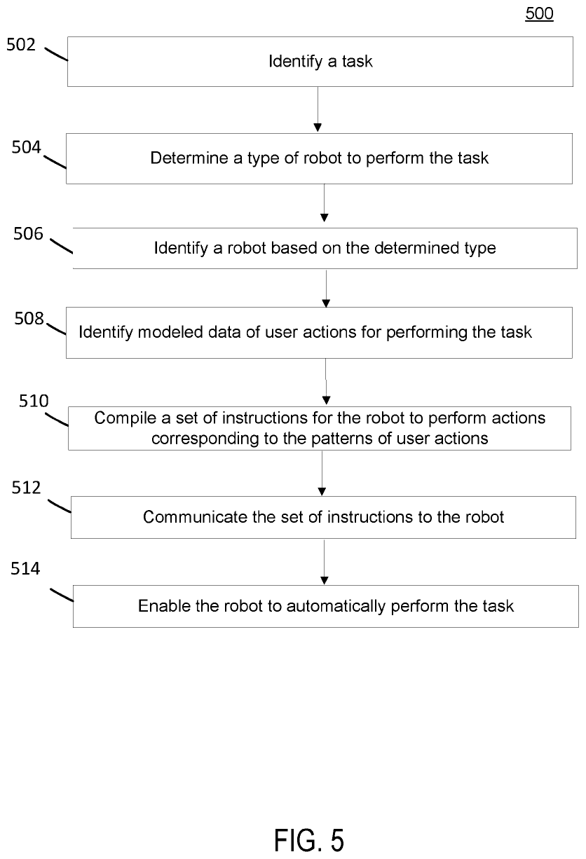

According to some embodiments, as discussed in more detail below, operation engine 200 may be configured to implement and/or control a plurality of services and/or microservices, where each of the plurality of services/microservices are configured to execute a plurality of workflows associated with performing the disclosed security management. Non-limiting embodiments of such workflows are provided below in relation to at least FIG. 3A, FIG. 3B, FIG. 4, and FIG. 5.

According to some embodiments, as discussed above, operation engine 200 may function as an application provided by cloud system 106. In some embodiments, engine 200 may function as an application installed on a server(s), network location and/or other type of network resource associated with system 106. In some embodiments, operation engine 200 may function as an application operating via an edge device (not shown) at location associated with system 100. In some embodiments, engine 200 may function as application installed and/or executing on UE 102. In some embodiments, such application may be a web-based application accessed by UE 102, peripheral device 110 and/or devices associated with sensors 112 over network 104 from cloud system 106. In some embodiments, engine 200 may be configured and/or installed as an augmenting script, program or application (e.g., a plug-in or extension) to another application or program provided by cloud system 106 and/or executing on UE 102, peripheral device 110 and/or sensors 112.

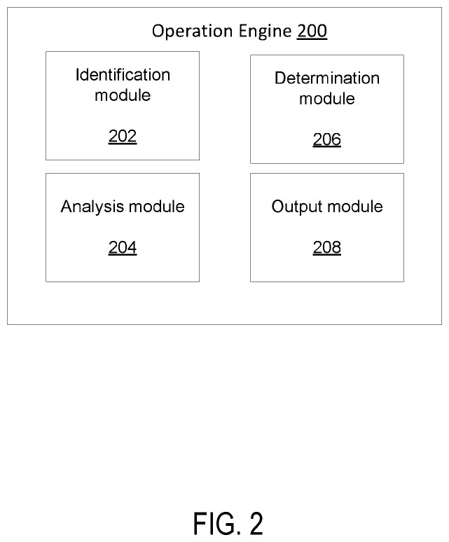

As illustrated in FIG. 2, according to some embodiments, operation engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3A, Process 300 provides non-limiting example embodiments for the disclosed framework. According to some embodiments, Process 300 provides computerized mechanisms for centralized management of a location and workers operating therein via detected, analyzed and monitored behaviors of the workers (referred to as users).

According to some embodiments, Steps 302-308 of Process 300 can be performed by identification module 202 of operation engine 200; Steps 310-314 (and sub-steps 350-364 of Step 314 in FIG. 3B) can be performed by analysis module 204; Step 316 can be performed by determination module 206; and Steps 318-322 can be performed by output module 208.

According to some embodiments, Process 300 begins with Step 302 where engine 200 can identify a user a location (e.g., jobsite, as discussed above, for example). In some embodiments, the identification can correspond to, but is not limited to, a request from another user (e.g., a manager at the location), motion detection by a camera, inactivity detected by a camera in relation to the user, a request by the user to be monitored, a schedule for monitoring specific staff at the location, a type of task associated with the user, and the like, or some combination thereof.

In some embodiments, operations, execution and implementation of engine 200 can be in relation to a device(s) at the location (e.g., local operating device); and in some embodiments, engine 200 can be operating on a remotely located device that can remotely access the data collected for the location and perform the operational steps outlined herein respective to Process 300 (and/or Processes 400 and 500, discussed infra).

In Steps 304, engine 200 can connect to the sensors, which as discussed above, can be associated with the user and/or a particular position(s) at/around the location. Such connectivity can be performed via the mechanisms discussed above at least in relation to FIG. 1. In some embodiments, connectivity between engine 200 and the sensors may already be established; therefore, Step 304 can involve identifying the sensors, and in some embodiments, sending a ping message to check the connection.

In some embodiments, Step 304's connection can involve the configuration of each identified sensor and its pairing/connection with engine 200 and/or each other. Accordingly, in some embodiments, with reference to FIG. 1, for example, sensors 112 can be paired with each other, with engine 200 and/or UE 102, which can be paired via connectivity protocols provided and/or enabled via engine 200. For example, a sensor 112 can be paired/connected with another sensor 112, engine 200, UE 102 and/or peripheral device 110 via BLE technology. In some embodiments, the sensors 112 can be paired and/or connected with another sensor 112, engine 200, UE 102 and/or peripheral device 110 via a physical wire connection (e.g., fiber, ethernet, coaxial, and/or any other type of known or to be known wiring to hardwire a location for network connectivity for devices operating therein). In some embodiments, the sensors 112 can be paired/connected with another sensor 112, engine 200, UE 102 and/or peripheral device 110 via a cloud-to-cloud (C2C) connection (e.g., establish connection with a third party cloud, which connects with cloud system 106, for example). In some embodiments, the sensors 112 can be paired/connected via a combination of network capabilities, hard wiring and/or C2C. In some embodiments, the sensors 112 can be paired so as enable an extended reach of the sensor's configuration to detect specific types of events.

In some embodiments, sensors 112 can be paired/connected with an imaging device 114, as discussed below at least in relation to Step 306.

In Step 306, engine 200 can identify a camera(s) at the location (e.g., positioned in the location and/or associated with UE 102, as discussed above). In some embodiments, the identification can involve connecting to the camera via network 104 and/or any of the pairing mechanisms discussed above. In some embodiments, Step 306 can involve identifying the camera (and in some embodiments, sending a ping message to check the connection and/or responsiveness of the camera). In some embodiments, Step 306 can involve pairing/connecting the camera with engine 200, sensors 112, UE 102 and/or peripheral device 110, which can occur via any of the mechanisms discussed above at least in relation to Step 304.

In Step 308, engine 200 can identify an assigned task for the user. According to some embodiments, the assigned task can be, but is not limited to, provided by the user, provided by an administrator or other user at the location, identified during Step 302, extracted from a jobsite manifest, identified/determined from a log of worker activity, identified via captured imagery of the user, and the like.

It should be understood that while the discussion herein will be discussed in reference to a single task for a single user at a single location, it should not be construed as limiting, as one of ordinary skill in the art would readily understand that the applicability of the disclosed engine 200's functionality and capabilities can extend to multiple tasks, multiple users and multiple locations without departing from the scope of the instant disclosure.

According to some embodiments, Step 308 can involve identifying a task schedule (or manifest) for the jobsite. The schedule can correspond to particular shifts, workers, types of tasks, positions within the location, types of used machinery, and the like or some combination thereof. In some embodiments, Step 308 can involve engine 200 searching a storage (e.g., database 108) of stored schedules, and identifying a task schedule for the user. The search can involve a query that includes an identifier of the user identified in Step 302. In some embodiments, Step 308 can involve extracting task information according to a schedule from an electronic document that includes a schedule for at least the user.

In some embodiments, Step 308 can involve a real-time analysis of the user to determine the activities of the user so as to determine which task the user is performing. In some embodiments, such analysis can involve capturing a set of images of the user (e.g., a single image or a plurality of images, for example), and analyzing such images to determine which activities the user is performing in the images. The output of the analysis can be compared against schedule information of the user so as to determine (and in some embodiments, confirm) the specific activities of the user

In some embodiments, by way of a non-limiting example, engine 200 can utilize any type of known or to be known artificial intelligence or machine learning algorithm or technique including, but not limited to, computer vision, classifier, feature vector analysis, decision trees, boosting, support-vector machines, neural networks (e.g., convolutional neural network (CNN), recurrent neural network (RNN), and the like), nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

For example, engine 200 can capture the images of the user (e.g., which can be captured according to a predetermined period of time), and input them into software defined by computer vision, for example. The output can be compared against a schedule to determine/confirm the activity of the user. In some embodiments, such output can be translated to a n-dimensional feature vector, whereby the nodes and edges of the output vector can be compared to a feature vector of the schedule. In some embodiments, upon the output matching a task (e.g., node) on the schedule's feature vector at least a threshold satisfying degree (e.g., which can be determined via a similarity analysis performed by engine 200 executing a similarity analysis algorithm, e.g., cosine similarity, for example), the assigned task of the user can be identified/confirmed.

In Step 310, engine 200 can monitor the activities of the user respective to the performance of the assigned task. In some embodiments, the monitoring can be enabled via engine 200 collecting and analyzing the data collected via sensors 112 and/or imaging device 114, which were identified/connected via Steps 304 and 306, respectively.

According to some embodiments, the disclosed monitoring can occur according to a setting/criteria, which can include, but is not limited to, the detection of activity of a user, detected presence of the user (e.g., via a sensor/camera), identification of the user (e.g., in Step 302), a request from another user to perform monitoring, a time, date, continuously, a predetermined interval, a dynamically determined interval (which can be based on the type of activity determined in Step 308), and the like, or some combination thereof. For example, if a task is determined/identified to be a dangerous task (e.g., handling of hazardous materials, for example), then the monitoring cycle/interval may be increased with the determined/perceived risk of the task.

Accordingly, in some embodiments, as discussed below, the monitoring enables the capture of sensor and/or camera data (e.g., via the connected/identified sensors from Steps 304 and 306, respectively).

In Step 312, engine 200 can capture data corresponding to the monitored activities. According to some embodiments, the captured data can be stored in a database in association with an identifier (ID) of the user and/or the task (and/or the location).

According to some embodiments, the captured data can correspond to live-streamed/collected data via sensors 112 and/or cameras 114, previously streamed/collected and stored data, and/or delayed streamed data.

According to some embodiments, engine 200 can operate to trigger the identified sensors and/or camera(s) to begin collecting data. According to some embodiments, the sensor data can be collected continuously and/or according to a predetermined period of time or interval. In some embodiments, sensor data may be collected based on detected events. In some embodiments, type and/or quantity of sensor data may be directly tied to the type of sensor. For example, a motion detection sensor may only collect sensor data when movement is detected in the field of view of the motion detection sensor. In another non-limiting example, a gyroscope sensor on a user's smartphone can detect when a user is moving, the type and/or metrics of such movements.

Accordingly, in some embodiments, camera data can correspond to captured imagery. As discussed above, the imagery can be captured by the camera(s) based on, but not limited to, a request, continuously, a predetermined interval, and the like, or some combination thereof.

In Step 314, engine 200 can analyze the captured data via a trained AI/ML algorithm(s). According to some embodiments, the AI/ML-based analysis can be performed via the AI/ML algorithms discussed above at least in relation to Step 308. For example, engine 200 can execute Step 314 via any type of known or to be known AI/ML algorithm or technique including, but not limited to, computer vision, classifier, feature vector analysis, decision trees, boosting, support-vector machines, neural networks, nearest neighbor algorithms, Naive Bayes, bagging, random forests, logistic regression, and the like.

According to some embodiments, the analysis performed by Step 314 can be performed via the sub-steps outlined in FIG. 3B (e.g., Steps 350-364).

Turning to FIG. 3B, provided are non-limiting example embodiments of the computational analysis applied and/or executed by engine 200 in some embodiments of Step 314 respective to the data captured in Step 312.

According to some embodiments, the processing of Step 314 begins with sub-step 350, where engine 200 can execute a classifier algorithm to determine a type of activity performed by the user. In some embodiments, the input of sub-step 350 can be the captured data, as discussed above.

According to some embodiments, the applied classifier algorithm can be any type of computational analysis classifier that can analyze captured sensor/camera data and determine a type of activity. For example, engine 200 can execute a TensorFlow algorithm.

In sub-step 352, engine 200 can output modeled data based on execution of the classifier (e.g., the TensorFlow algorithm). Thus, for example, engine 200 can determine a type of activity the user is performing in the captured imagery by the camera(s) and/or movements performed based on the sensor data.

In sub-step 354, the determined output from sub-step 354 can be stored in a database in association with an ID of the user and/or the task (and/or the location). In some embodiments, such output can be provided for further training of the applied AI/ML models (e.g., sub-step 364, as depicted in FIG. 3B).

In sub-step 356, engine 200 can execute a kinematics algorithm. In some embodiments, the kinematics algorithm can involve, but is not limited to, serial and/or parallel manipulator analysis related to the captured data. In some embodiments, input into sub-step 356 can be, but is not limited to, the captured data and/or the output from sub-step 352.

According to some embodiments, sub-step 356 can output data related to movements of the user, which can be related to, but not limited to, particular movements of particular body parts (e.g., which movements an arm performed, which movements a finger performed, what was the users posture or stance, an angle and/or velocity of movement of the user (and/or particular body parts—for example, at what angle and velocity did the user's arms move), a starting position of the user/body parts, ending position of the user/body parts, and the like, or some combination thereof).

In sub-step 358, the determined output from sub-step 356 can be stored in a database in association with an ID of the user and/or the task (and/or the location). In some embodiments, such output can be provided for further training of the applied AI/ML models (e.g., sub-step 364, as depicted in FIG. 3B).

In sub-step 360, engine 200 can execute a graphical information system (GIS) algorithm (or model). According to some embodiments, the input into the GIS algorithm can be the capture data, the output from sub-step 352 and/or the output from sub-step 356, or some combination thereof.

According to some embodiments, execution of the GIS algorithm by engine 200 can enable a mapping of the location and/or proximate area around the user at the location (e.g., a 3D mapping of a predetermined position around the user and the user's movements—for example, 3D mapping of the space 2 meters around the user in the x, y, z plane). In some embodiments, the mapping can further enable a tracking of the user's movements represented in the captured data and analyzed via sub-steps 352 and 356 in a 3D space. In some embodiments, an output of the GIS algorithm can involve 2D or 3D representation of real-world elements as graphical elements, which can be in a grid space (e.g., raster) or line-based (e.g., vector) model.

In sub-step 362, the determined output from sub-step 360 can be stored in a database in association with an ID of the user and/or the task (and/or the location). In some embodiments, such output can be provided for further training of the applied AI/ML models (e.g., sub-step 364, as depicted in FIG. 3B).

Thus, Step 314 can effectuate a determination and generated mapping of the user's movements, specific to the user in general down to specific limbs/body parts, in a 3D representative space of the location. For example, Step 314 can determine a mapping of a displacement of a user's torso joints from an initial position to a new position in 3D. The mapping can indicate the velocity of displacement, acceleration of displacement, angular velocity of displacement, overall time to perform the displacement (or task), and the like, or some combination thereof. Thus, according to some embodiments, the mapping can provide kinematics of the user, which can include information related to the user's actions, identity, demographics, biometrics, and the like, or some combination thereof.

Turning back to FIG. 3A, processing proceeds to Step 316 where engine 200 can determine a performance of the user based on the analysis from Step 314. According to some embodiments, engine 200 can determine a performance value, metric or measurement of the user based on the captured movements of the user (from Step 312), which can include, but is not limited to, a current fatigue, strength, energy/activity level, mood, type of activity, body positioning, speed of moment, angle of movement, trajectory of movement, non-movement, and the like, or some combination thereof. According to some embodiments, the performance of the user can correspond to, but are not limited to, the activities of the user, compliance with particular (or governing) laws and regulations, safety/security measures, and the like. For example, as discussed herein, the performance can indicate that the user is performing their job/task at a level or in a manner that violates a regulation for a particular employee (e.g., not wearing a hard-hat in a particularly zoned region of the location, for example).

According to some embodiments, Step 316 can involve leveraging the output from step 314 as input into an AI/ML model to determine the performance of the user, which can include, but is not limited to, logistic regression, linear regression, stepwise regression, multivariate adaptive regression splines (MARS), least squares regression (LSR), neural networks, random forest, and the like. Thus, based on such analysis, Step 316 can enable engine 200 determine a performance metric for the user. For example, a performance value can be determined for a user according to a scale (e.g., 1-10, where 10 is the highest performance, for example). In some embodiments, the scale may be adjusted and/or dynamically modified (e.g., increased value to 1-20, for example) for more or less difficult tasks and task types. In some embodiments, further discussion of the determined performance information is discussed further in relation to Steps 402-404 of Process 400 of FIG. 4, discussed infra.

In Step 318, engine 200 can store data related to the determined performance in storage, which can be stored in association with an ID of the user, task and/or location, as discussed above.

In Step 320, engine 200 can utilize the determined performance information from Step 316 to further train the AI/ML algorithms applied/executed by engine 200.

In Step 322, engine 200 can generate an output based on the determined performance, which can be output to the user or a set of users, as discussed in more detail below with at least reference to FIG. 4. For example, a manager can receive the generated output as an electronic message that includes content corresponding to the user's determined performance. In another non-limiting example, as discussed below, the user may receive an alert on UE 102, which can inform the user as to their current fitness status.

According to some embodiments, engine 200 may perform operations to determine if the user has other tasks to be performed (e.g., from the schedule for the user, for example). This is depicted in FIG. 3 via the dashed line from Step 322 to Step 308, whereby if there is another task to be performed, and the user is permitted/assigned that task, processing of Process 300 by engine 200 can recursively continue.

Turning to FIG. 4, Process 400 is provided which details non-limiting example embodiments for automatically communicating an alert related to the determined performance of a user (e.g., via Process 300, discussed supra).

According to some embodiments, Process 400 can occur in real-time (or substantially in real-time), in that, as data is captured related to a user's performance of a task, and performance determinations are made (e.g., via Step 316), Process 400 can execute so as to provide real-time feedback to the user and/or other users at or associated with the location. In some embodiments, Process 400 can operate by retrieving stored performance data about a user, and performing the analysis herein (e.g., for a performance review and/or to further train the algorithms implemented by engine 200).

According to some embodiments, Step 402 of Process 400 can be performed by analysis module 204 of operation engine 200; Step 404 can be performed by determination module 206; and Steps 406-414 can be performed by output module 208.

According to some embodiments, Process 400 begins with Step 402 where engine 200 can analyze the determined performance of the user for a specific task. In some embodiments, for example, the determined performance can correspond to the performance determined via Process 300, discussed supra. In some embodiments, the analysis of the determined performance can be performed, in a similar manner as discussed above in relation to Step 316, via AI/ML models to determine the performance of the user, which can include, but is not limited to, logistic regression, linear regression, stepwise regression, MARS, LSR, neural networks, random forest, and the like.

In some embodiments, the analysis performed in Step 402 can be respective to a performance threshold, which can be, but is not limited to, the user, a type of user, level of user, experience of user, type of task, length of task, difficulty of task, laws/regulations associated with the task, industry and/or jobsite, environmental conditions (e.g., temperature at the location, climate at the location, and the like), time of day, month of year, and the like, or some combination thereof.

In Step 404, a value associated with the performance can be determined by engine 200 based on the analysis of Step 402. This can be performed in a similar manner as discussed above. For example, the value of the performance may be a 5/10, and the performance threshold for that task is a 6/10, which may indicate that the user is not performing up to industry standards/efficiency/safety.

In Step 406, engine 200 can generate an alert based on the determined value. In some embodiments, an alert can be generated when the determined performance value (or metric) is at or below a performance threshold. In some embodiments, the value of the performance, and in some embodiments, its range to the performance threshold, may be used as a basis by engine 200 determine a type of alert and/or type of user to send the alert to.

For example, if the alert indicates that the user is operating a machine for a task at a dangerous level, then a manager may be notified via an SMS message. In another example, the same user may also, or alternatively, receive a haptic message sent to their UE, sensor or peripheral device, which can alert the user to stop working. Similarly, a voice alert can be sent that instructs the user to “stop”. In some embodiments, engine 200 can utilize a natural language processing (NLP) algorithm to equate the level of performance to an audible message. In some embodiments, a collection of types of messages, inclusive of audio, video, text and/or images, may be stored in a database and retrieved by engine 200 as part of the message generation processing.

Thus, in some embodiments, upon generation of the alert, engine 200 can send the alert to the user, as in Step 408. In some embodiments, as discussed above, the alert can be any type of electronic message, and can include any type of renderable digital content. In some embodiments, the alert can be sent via an application executing on a device of the user that corresponds to the functionality of engine 200.

In some embodiments, for example, the alert in Step 408 can inform the user as to another or next assigned task that has a difficulty that more matches their current performance level. Such determination can be performed via engine 200 matching the determined performance level, at least to a threshold degree, to a level associated with another identified task of scheduled tasks for the location.

In some embodiments, for example, the alert can determine a dangerous condition associated with a position where the user is performing the current task (e.g., a fire, for example); therefore, the alert can instruct the user to leave that position and report to a safe-designated place. Thus, the alert can reroute the user as to a different position, different task, and/or stop working entirely, for example.

In some embodiments, for example, the alert can inform the user of, but not limited to, their performance value (e.g., respective to the performance threshold of the task they are performing), a hazardous condition, incorrect technique and/or other undesirable behavior or location conditions.

In some embodiments, upon generation of the alert, engine 200 can send the alert to an identified at least one other user associated with the location, as in Step 410. In some embodiments, Step 410 can involve the identification of such other users. In some embodiments, as discussed above, the alert can be any type of electronic message, and can include any type of renderable digital content. In some embodiments, the alert can be sent via an application executing on a device of the identified other user(s) that corresponds to the functionality of engine 200. In some embodiments, the alert can be broadcast over speakers at the location for audible reception by all users, which may occur should the performance of the user correspond to a dangerous activity level or task. In some embodiments, the alert can also be sent to a third party (e.g., first responder, such as the fire department, for example) when the performance information may indicate an injury to a worker user.

According to some embodiments, the alerts communicated via Steps 408 and 410 can be any type of one-way, two-way or multiway communication via text, voice, voice recognition, and the like, or some combination thereof.

In Step 412, information/data related to the communicated alerts can be stored in a database. In some embodiments, as discussed above, such information can correspond to an ID of the user, task and/or location. In some embodiments, the stored information can indicate the performance value, and information related to the generated alert(s) (e.g., type of alert, type of content, when it was sent, who it was sent to, and the like).

And, in Step 414, the stored information (or at least the information analyzed, determined and/or generated during processing of Process 400) can be utilized to further train the AI/ML algorithms executed by engine 200. This, as discussed herein, can enable a more refined, efficient and accurate identification of performance levels and/or safety-backstops for working users.

Turning to FIG. 5, Process 500 provides non-limiting example embodiments for utilizing the stored activity data of a user and/or determined performance of the user (from Processes 300-400, discussed supra) to automate performance of a task via a computer-operated machine (or asset)—referred to as a robot, for explanation purposes only. As discussed herein, the activity data can provide kinematics of the operating users, which can be transferred to robotic workers, thereby enabling their automatic operation and performance of particular tasks.

By way of a non-limiting example, a robot (or robotic worker, used interchangeably), for purposes of this discussion, can be any type of real-world or controlled asset at a location that can perform a real-world or digital task. In some embodiments, the robot can be computer-operated entirely or at least partially computer-operated. In some embodiments, the robot may be and/or integrate with supportive mechanisms, external machinery and/or exoskeletons, for example.

According to some embodiments, Steps 502 and 506 of Process 500 can be performed by identification module 202 of operation engine 200; Steps 504, 508 and 510 can be performed by determination module 206; Steps 512-514 can be performed by output module 208.

According to some embodiments, Process 500 begins with Step 502 where a task is identified by engine 200. According to some embodiments, the identification of the task can be performed in a similar manner as discussed above in relation to at least Step 308 of Process 300.

In Step 502, engine 200 can analyze the task, and determine a type of robot that is capable and/or configured to perform the task. In some embodiments, such analysis can identify sub-parts, sub-routines and/or specific sequences of actions for the task. According to some embodiments, engine 200 can utilize any type of known or to be known AI/ML algorithm or technique to analyze a data file associated with a task, and determine the specific actions for the task (e.g., a neural network, as discussed above).

In some embodiments, the specific actions and/or sub-parts of the task can be compiled via stored modeled data of user actions for the task, as discussed above at least in relation to Step 314. In some embodiments, engine 200 can analyze the determined, mapping or modeled data of users that have performed the task previously at or above the predetermined threshold, and determine the steps of the task accordingly.

In Step 506, the robot for performance (or usage) of the task can be identified based on the type of robot (and in some embodiments, the type of task).

In Step 508, the modeled data for performance of the task can be identified by engine 200. According to some embodiments, as discussed above, the modeled data can correspond to the determined 3D mapping determined via Step 314. In some embodiments, a specific performance value or desired/requested type or value of kinematics of an operating user may be utilized as a search criteria to identify the modeled data (e.g., at least 8/10 to identified stored, modeled data from a database).

In Step 510, engine 200 can compile a set of instructions for the robot to perform, which can include the specific actions for the robot to sequentially perform the task to completion, accurately (and in some embodiments, efficiently—e.g., within a certain period of time). In some embodiments, engine 200 can parse the modeled data and extract information related to the specific steps indicated therein, and generate an executable, machine readable data structure or file that contains the processing steps for the task in an order for accurately performing the task.

In some embodiments, such compiled instructions can be stored in storage (e.g., a database) in association with an ID of the task, location, robot and/or user from which the modeled data originated from.

In Step 512, engine 200 can communicate and/or cause the loading of the instructions into the robot. The robot can be caused to execute the instructions according to execution of the provided instructions, as in Step 514. Thus, the robot can automatically perform the task via the provided instructions.

In some embodiments, the robot can be configured with wearable and/or embedded/attached sensors at specific points on/around the robot, so that specific instructions cause the robot to be manipulated by such attached sensors.

FIG. 8 is a schematic diagram illustrating a client device showing an example embodiment of a client device that may be used within the present disclosure. Client device 800 may include many more or less components than those shown in FIG. 8. However, the components shown are sufficient to disclose an illustrative embodiment for implementing the present disclosure. Client device 800 may represent, for example, UE 102 discussed above at least in relation to FIG. 1.

As shown in the figure, in some embodiments, Client device 800 includes a processing unit (CPU) 822 in communication with a mass memory 830 via a bus 824. Client device 800 also includes a power supply 826, one or more network interfaces 850, an audio interface 852, a display 854, a keypad 856, an illuminator 858, an input/output interface 860, a haptic interface 862, an optional global positioning systems (GPS) receiver 864 and a camera(s) or other optical, thermal or electromagnetic sensors 866. Device 800 can include one camera/sensor 866, or a plurality of cameras/sensors 866, as understood by those of skill in the art. Power supply 826 provides power to Client device 800.

Client device 800 may optionally communicate with a base station (not shown), or directly with another computing device. In some embodiments, network interface 850 is sometimes known as a transceiver, transceiving device, or network interface card (NIC).

Audio interface 852 is arranged to produce and receive audio signals such as the sound of a human voice in some embodiments. Display 854 may be a liquid crystal display (LCD), gas plasma, light emitting diode (LED), or any other type of display used with a computing device. Display 854 may also include a touch sensitive screen arranged to receive input from an object such as a stylus or a digit from a human hand.

Keypad 856 may include any input device arranged to receive input from a user. Illuminator 858 may provide a status indication and/or provide light.

Client device 800 also includes input/output interface 860 for communicating with external. Input/output interface 860 can utilize one or more communication technologies, such as USB, infrared, Bluetooth™, or the like in some embodiments. Haptic interface 862 is arranged to provide tactile feedback to a user of the client device.

Optional GPS transceiver 864 can determine the physical coordinates of Client device 800 on the surface of the Earth, which typically outputs a location as latitude and longitude values. GPS transceiver 864 can also employ other geo-positioning mechanisms, including, but not limited to, triangulation, assisted GPS (AGPS), E-OTD, CI, SAI, ETA, BSS or the like, to further determine the physical location of client device 800 on the surface of the Earth. In one embodiment, however, Client device may through other components, provide other information that may be employed to determine a physical location of the device, including for example, a MAC address, Internet Protocol (IP) address, or the like.

Mass memory 830 includes a RAM 832, a ROM 834, and other storage means. Mass memory 830 illustrates another example of computer storage media for storage of information such as computer readable instructions, data structures, program modules or other data. Mass memory 830 stores a basic input/output system (“BIOS”) 840 for controlling low-level operation of Client device 800. The mass memory also stores an operating system 841 for controlling the operation of Client device 800.

Memory 830 further includes one or more data stores, which can be utilized by Client device 800 to store, among other things, applications 842 and/or other information or data. For example, data stores may be employed to store information that describes various capabilities of Client device 800. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 800.

Applications 842 may include computer executable instructions which, when executed by Client device 800, transmit, receive, and/or otherwise process audio, video, images, and enable telecommunication with a server and/or another user of another client device. Applications 842 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, Javascript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a device, a task to be performed at a location by a user;
identifying, by the device, a monitoring device at the location;
monitoring, by the device via the monitoring device, activities of the user in relation to performance of the task;
capturing, by the device, data related to the activities of the user related to the performance of the task;
analyzing, by the device, the captured data;
determining, by the device, performance information of the user; and
generating, by the device, an alert based on the performance information.

2. The method of claim 1, further comprising:
analyzing the performance information, and determining a performance value for the task by the user; and
determining, based on the analysis of the performance information, a type of the alert, the determination further comprising determining an identity of a destination to send the alert.

3. The method of claim 2, wherein the alert is sent to a device associated with the user.

4. The method of claim 2, wherein the alert is sent to at least one device of another user.

5. The method of claim 1, wherein the analysis of the capture data further comprises:
executing a classifier to determine a type of the activities of the user;
executing a kinematics algorithm to determine movement information related to the activities;
executing a geographic information system (GIS) algorithm based at least one the captured data;
generating, based on the execution of the classifier, kinematics algorithm and GIS algorithm, a three-dimensional (3D) mapping of the activities of the user respective to the location; and
storing the 3D mapping in a database.

6. The method of claim 5, further comprising:
analyzing the task, and determining, based on the task analysis, sequential steps for performance of the task;
identifying a type of robot based on analysis of the task;
analyzing the 3D mapping;
determining, based at least on one of the analysis of the 3D mapping, automated learning algorithms for automatically analyzing and learning the task and the sequential steps for the task, a set of instructions for the robot to automatically perform the task;
compiling the set of instructions as a machine-readable data structure; and
communicating, over a network, the data structure to the robot, the communication causing the robot to automatically execute the sequential steps according to a performance value provided by the 3D mapping.

7. The method of claim 1, wherein the monitoring device comprises at least one of a sensor associated with the location, a sensor associated with the user, a camera associated with the location and a camera associated with the user.

8. The method of claim 1, wherein the task comprises at least one of real-world and digital operations.

9. A device comprising:
at least one processor configured to:
identify a task to be performed at a location by a user;
identify a monitoring device at the location;
monitor, via the monitoring device, activities of the user in relation to performance of the task;
capture data related to the activities of the user related to the performance of the task;
analyze the captured data;
determine performance information of the user; and
generate an alert based on the performance information.

10. The device of claim 9, wherein the processor is further configured to:
analyze the performance information, and determine a performance value for the task by the user; and
determine, based on the analysis of the performance information, a type of the alert, the determination further comprising determining an identity of a destination to send the alert.

11. The device of claim 10, wherein the alert is sent to a device associated with the user.

12. The device of claim 10, wherein the alert is sent to at least one device of another user.

13. The device of claim 9, wherein the processor is further configured to:
execute a classifier to determine a type of the activities of the user;
execute a kinematics algorithm to determine movement information related to the activities;
execute a geographic information system (GIS) algorithm based at least one the captured data;
generate, based on the execution of the classifier, kinematics algorithm and GIS algorithm, a three-dimensional (3D) mapping of the activities of the user respective to the location; and
store the 3D mapping in a database.

14. The device of claim 13, wherein the processor is further configured to:
analyze the task, and determine, based on the task analysis, sequential steps for performance of the task;
identify a type of robot based on analysis of the task;
analyze the 3D mapping;
determine, based on at least one of the analysis of the 3D mapping, automated learning algorithms for analyzing and learning the task and the sequential steps for the task, a set of instructions for the robot to automatically perform the task;
compile the set of instructions as a machine-readable data structure; and
communicate, over a network, the data structure to the robot, the communication causing the robot to automatically execute the sequential steps according to a performance value provided by the 3D mapping.

15. A non-transitory computer-readable storage medium tangibly encoded with computer-executable instructions that when executed by a device, performs a method comprising:
identifying, by the device, a task to be performed at a location by a user;
identifying, by the device, a monitoring device at the location;
monitoring, by the device via the monitoring device, activities of the user in relation to performance of the task;
capturing, by the device, data related to the activities of the user related to the performance of the task;
analyzing, by the device, the captured data;
determining, by the device, performance information of the user; and
generating, by the device, an alert based on the performance information.

16. The non-transitory computer-readable storage medium of claim 15, further comprising:
analyzing the performance information, and determining a performance value for the task by the user; and
determining, based on the analysis of the performance information, a type of the alert, the determination further comprising determining an identity of a destination to send the alert.

17. The non-transitory computer-readable storage medium of claim 16, wherein the alert is sent to a device associated with the user.

18. The non-transitory computer-readable storage medium of claim 16, wherein the alert is sent to at least one device of another user.

19. The non-transitory computer-readable storage medium of claim 15, wherein the analysis of the capture data further comprises:
executing a classifier to determine a type of the activities of the user;
executing a kinematics algorithm to determine movement information related to the activities;
executing a geographic information system (GIS) algorithm based at least one the captured data;
generating, based on the execution of the classifier, kinematics algorithm and GIS algorithm, a three-dimensional (3D) mapping of the activities of the user respective to the location; and
storing the 3D mapping in a database.

20. The non-transitory computer-readable storage medium of claim 19, further comprising:
analyzing the task, and determining, based on the task analysis, sequential steps for performance of the task;
identifying a type of robot based on analysis of the task;
analyzing the 3D mapping;
determining, based on at least one of the analysis of the 3D mapping, automated learning algorithms for analyzing and learning the task and the sequential steps for the task, a set of instructions for the robot to automatically perform the task;
compiling the set of instructions as a machine-readable data structure; and
communicating, over a network, the data structure to the robot, the communication causing the robot to automatically execute the sequential steps according to a performance value provided by the 3D mapping.
